(19) United States
(12) Patent Application Publication
(10) Pub. No.: US 2019/0318742 A1
(43) Pub. Date: Oct. 17, 2019

(54) COLLABORATIVE AUTOMATIC SPEECH RECOGNITION

(71) Applicant: Intel Corporation, Santa Clara, CA (US)

(72) Inventors: Shobhit Srivastava, Bangalore (IN); Dinesh Kumar Sharma, Bangalore (IN); Archana Patni, Bangalore (IN); Jenny Tharayil Chakunny, Bangalore (IN); Sangram Kumar Yerra, Bangalore (IN); Naveen Manohar, Bangalore (IN)

(21) Appl. No.: 16/453,156

(22) Filed: Jun. 26, 2019

(51) Int. Cl. G10L 15/30; G10L 15/32; G10L 15/26; G10L 15/14

(52) U.S. Cl. CPC G10L 15/30; G10L 15/14; G10L 15/26; G10L 15/32

(57) ABSTRACT

In some embodiments, a method receives a plurality of portions of recognized speech from a plurality of devices. Each portion includes an associated confidence score and time stamp. For one or more time stamps associated with the plurality of portions, the method identifies two or more confidence scores for two or more of the plurality of portions of recognized speech. For the one or more time stamps, one of the two or more of the plurality of portions of recognized speech is selected based on the two or more confidence scores for the two or more of the plurality of portions. The method generates a transcript using the one of the two or more of the plurality of portions of recognized speech selected for the respective one or more time stamps.

### BACKGROUND

Automatic speech recognition (ASR) systems are being used to convert speech to text in various environments. For example, automatic speech recognition systems are used in information kiosks, call centers, smart home systems, autonomous driving systems, etc. One other use case for automatic speech recognition is performing meeting transcription to transcribe speech from the meeting in real time. Typically, a meeting may have multiple speakers that each speak at different times. These speakers may also have different accents or ways of speaking. The automatic speech recognition system may have problems recognizing some or all of the different characteristics of the speech from the different speakers. The meeting transcription may then suffer from some inaccuracies and thus not be as useful or even be used.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a simplified system for performing collaborative automatic speech recognition according to some embodiments.

FIG. 2 depicts a simplified flowchart of a method for training models for an automatic speech recognition system according to some embodiments.

FIG. 3 depicts a simplified flowchart of a method for initializing the collaborative automatic speech recognition process according to some embodiments.

FIG. 4 depicts a simplified flowchart of a method for performing automatic speech recognition according to some embodiments.

FIG. 5 depicts a simplified flowchart of a method for generating a final transcript according to some embodiments.

FIG. 6A depicts portions of text at a first time stamp according to some embodiments.

FIG. 6B shows an example of portions of recognized speech at a second time stamp according to some embodiments.

FIG. 6C shows an example of a final transcript according to some embodiments.

FIG. 7 depicts an example of the automatic speech recognition system according to some embodiments.

FIG. 8 depicts a simplified flowchart of a method for performing automatic speech recognition according to some embodiments.

FIG. 9 illustrates an example of special purpose computer systems configured with the automatic speech recognition system and the automatic speech recognition manager according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Some embodiments use a collaborative automatic speech recognition (ASR) approach to generate a transcription. In some embodiments, the collaborative automatic speech recognition approach may be used to generate a meeting transcription that includes text that is recognized from the speech of multiple users that are participating in the meeting. In some embodiments, multiple client devices are used to perform automatic speech recognition. One of the client devices may be designated a master device, which can generate the final transcript. Each client device may perform automatic speech recognition in isolation to generate recognized speech. In some embodiments, each user in the meeting may have an associated client device that performs automatic speech recognition. However, each user's client device may be trained based on the respective user's voice. For example, the training generates a model that is trained for the user's voice characteristics. Due to the training, each user's client device may perform a more accurate speech recognition when that user speaks in the meeting.

Each client device can perform automatic speech recognition using their respective models, and then send the recognized speech to the master device. The recognized speech may include a time stamp for when the speech was recognized and also a confidence score. The confidence score ranks the confidence of the accuracy of the speech. After receiving the speech from the client devices, the master device can generate the final transcript by selecting portions of the speech from different client devices. For example, for a first time stamp, the master device may select a portion of recognized speech from one of the client devices that has the highest confidence score. Then, for a second time stamp, the master device may select a second portion of recognized speech that has the highest confidence score from another client device. This process continues until the master device has generated a final transcript for the meeting. In some embodiments, the portions of text for the recognized speech that have the highest confidence level may be from the respective client devices that were trained with the user that was speaking that portion of text. Because the model is trained to recognize the respective user's voice characteristics, that automatic speech recognition system may perform the recognition more accurately than other automatic speech recognition system in other client devices. Thus, the final transcription may be more accurate than using a single automatic speech recognition system. Although a master device is described as performing the generation of the final transcript, one or more client devices may also perform the final combination. Having multiple client devices perform the combination provides a failover in case the master device fails or goes down.

System Overview

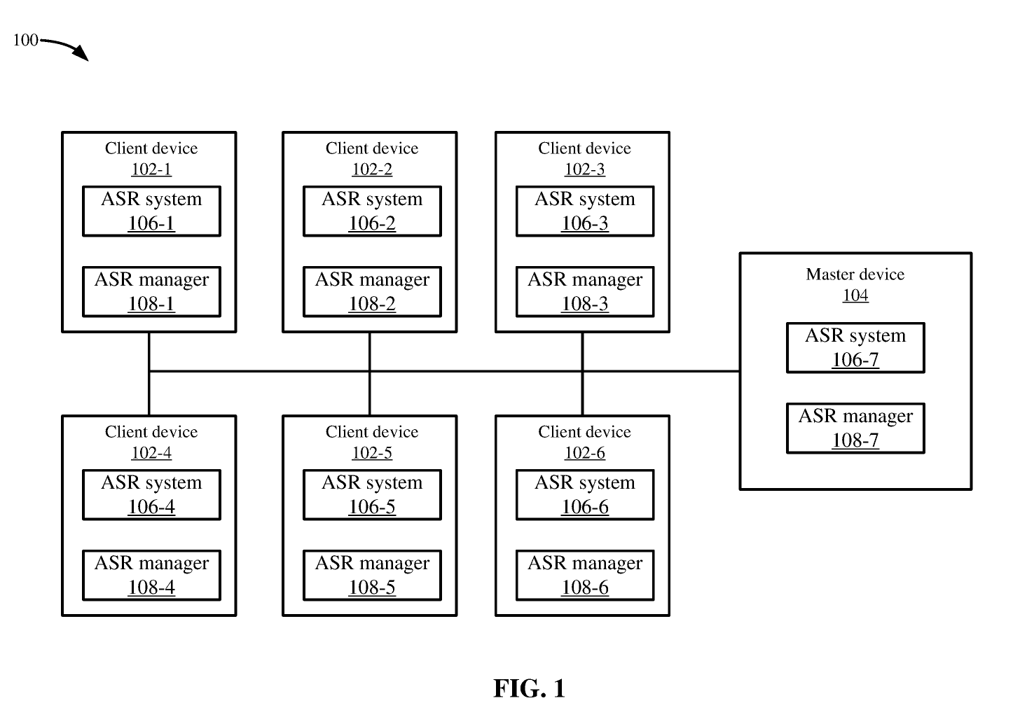

FIG. 1 depicts a simplified system 100 for performing collaborative automatic speech recognition according to some embodiments. System 100 includes client devices 102-1 to 102-6 and a master device 104. Client devices 102 and master device 104 may be computing devices, such as laptops, smartphones, etc. Master device 102 may be another client device that has been designated a master device. Although client devices 102 and master device 104 are discussed, a master device 104 may not be needed to perform the collaborative automatic speech recognition process. Rather, two or more client devices 102 may perform the collaborative automatic speech recognition process as described below.

Each client device 102 may include an automatic speech recognition (ASR) system 106, such as client device 102-1 to client device 102-6 include automatic speech recognition systems 106-1 to 106-6. Master device 104 also includes an automatic speech recognition system 106-7; however, master device 104 may not be performing automatic speech recognition. For example, master device 104 may be located remotely from client devices 102, such as in a data center where master device 104 only performs the final transcript generation and not automatic speech recognition. For discussion purposes, it is assumed master device performs automatic speech recognition.

In some embodiments, client devices 102 and master device 104 may be located in a location, such as a meeting room in which multiple users speak. Also, in some embodiments, each client device 102 and master device 104 may be placed in front of a respective user. For example, the users may be sitting at a conference table with each user's laptop in front of that user. In other examples, one or more client devices 102 or master device 104 may be virtually connected to a meeting, such as via a teleconference line. In either case, devices performing automatic speech recognition are in a location in which the devices can detect live speech from users that are speaking. The example will use a meeting in which multiple users speak as an example, but other events may be used, such as a lecture in which a professor and students speak.

Master device 104 includes an automatic speech recognition manager 108-7 that can generate a final transcript from the speech detected by ASR systems 106-1 to 106-7. The final transcript may incorporate speech detected by one or more client devices 102-1 to 102-6 and master device 104. Additionally, each client device 102-1 to 102-6 may include a respective ASR manager 108-1 to 108-6. In this example, one or more client devices 102 may also generate the final transcript. This distributes the generation of the transcript among multiple devices, which provides failover protection. For example, if master device 104 were to become disconnected from the meeting or go down, then other client devices 102 may be used to generate the final transcript. In other embodiments, only master device 104 may generate the final transcript.

Training

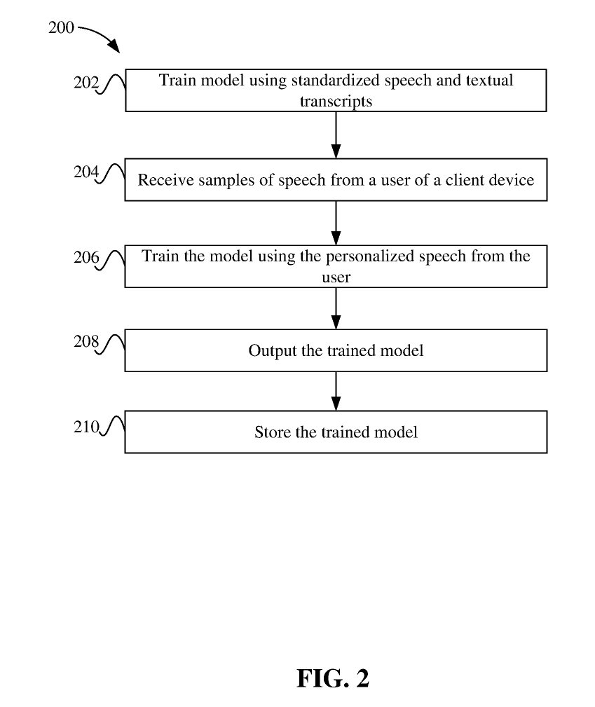

Before performing automatic speech recognition, automatic speech recognition systems 106 are trained. FIG. 2 depicts a simplified flowchart 200 of a method for training models for automatic speech recognition system 106 according to some embodiments. Each model may be trained specifically for a user that is associated with a client device 102. For example, a user #1 of client device 102-1 may train automatic speech recognition system 106-1, user #2 associated with client device 102-2 may train automatic speech recognition system 106-2, and so on. Accordingly, the following process may be performed for each automatic speech recognition systems 106-1 to 106-7.

At 202, client device 102 trains a model using standardized speech and textual transcripts. For example, the standardized speech may be speech from other users different from the specific user for client device 102. The textual transcripts may be text that corresponds to the standardized speech. The textual transcripts are accepted as being the correct recognition for the standardized speech. In some embodiments, a speed model that models a speed at which a user speaks and a language model that models how a user speaks are trained.

In a supervised approach, the standardized speech may be input into a prediction network, such as a neural network, which then outputs recognized speech. The recognized speech is compared to the corresponding textual transcript to determine how accurate the model was in recognizing the standardized speech. Then, the model may be adjusted based on the comparison, such as weights in the model are adjusted to improve the recognition. Although this method of training is used, other methods may be used. For example, unsupervised training may also be used where textual transcripts are not used to check the accuracy of the recognition.

At 204, client device 102 receives samples of speech from the user of client device 102. For example, the user may speak some phrases that are recognized by client device 102 as the samples. In other examples, the samples of speech may be received from recorded files from the user.

At 206, client device 102-1 trains the model using the personalized speech from the user. For example, the user may speak a phrase, which is repeated by client device 102, and the user can confirm the recognition output. In other examples, speech data from the user may be annotated into a textual transcript. Then, the speech data is input into the prediction network and compared to the textual transcript in the same way as discussed above at 202 to train the model.

The model may also be trained using unlabeled data from the user. This type of speech may be obtained by storing each request that a user makes while using the automatic speech recognition system 106. There still may not be enough labeled training data for a particular user. Client device 102 may use a dual supervised learning technique using two unlabeled datasets, a first set of speech recordings from a particular user and a second text corpora of language. Then, client device 102 trains the two models of a speed model and a language model simultaneously, and explicitly exploits the probabilistic correlation between them and generates a training model for a particular user. Also, a voice conversion model may use characteristics from the speech of a particular user to convert the standardized speech samples into a new sample that sounds like it was spoken by the particular user. For example, characteristics of the standardized speech are changed based on the user's pitch, loudness/volume, accent, language type, style of speaking, quality or timbre, or other personal parameters. The converted standardized speech samples with the textual transcripts are then used to train the model. Because the standardized speech samples have been converted to sound like the particular user, the model is trained to recognize speech characteristics of the user without having to determine a large amount of samples of the user's actual speech.

After training, at 208, client device 102 outputs the trained model. The trained model may have weights that were set based on the training using the user's voice characteristics. Then, at 210, client device 102 stores the trained model. For example, the trained model may be stored in client device 102 or may be stored in a library that stores multiple users' trained models. If stored in a central repository, client device 102 may download the trained model at a later time when automatic speech recognition is to be performed.

Collaborative Automatic Speech Recognition Initialization

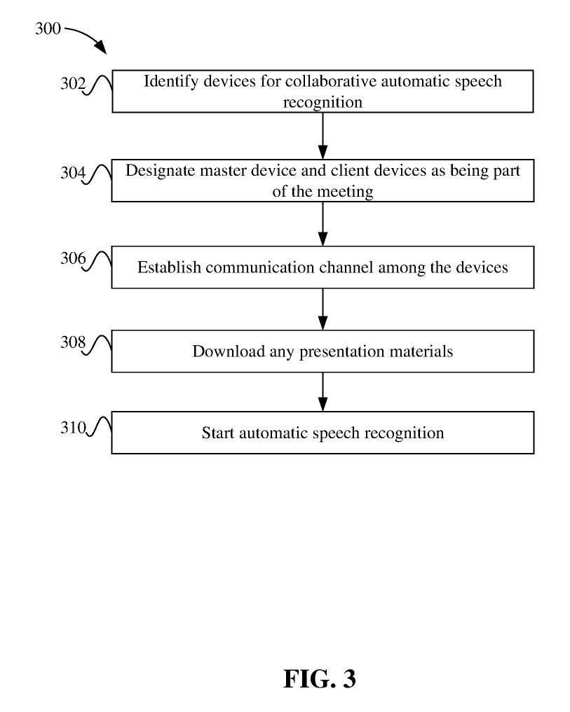

FIG. 3 depicts a simplified flowchart 300 of a method for initializing the collaborative automatic speech recognition process according to some embodiments. At 302, client devices 102 and master device 104 are identified for collaborative automatic speech recognition. For example, a device discovery phase is performed to identify each device. In some examples, client devices 102 and master device 104 may join a meeting in the discovery phase, such as via an advertised link. Or, client devices 102 and master device 104 may advertise their presence and are automatically discovered. The device discovery process discovers devices that may be physically present in the same location, such as the meeting room, or devices that are present virtually, such as via a conference call.

At 304, master device 104 and client devices 102 are designated as being part of the meeting. For example, master device 104 is designated as the master device based on who organized the meeting. The other discovered devices may be the client devices. Master device 104 and client devices 102 may also be designated in other ways, such as each client device 102 is designated as the master device.

At 306, a communication channel is established among the devices. For example, master device 104 establishes a communication channel with each client device 102. The communication channels may be established using any application layer solution, such as message queueing telemetry transport (MQTT), which uses a Transport Control Protocol/Internet Protocol (TCP/IP), and the channel may be a one or two way communication. Master device 104 may establish a communication channel with each client device 102 when only master device 104 performs the final transcript generation. In this case, each client device 102 only needs to communicate with master device 104, and not other client devices 102. In other embodiments, each client device 102 and master device 104 may establish a communication channel with each other. Client devices 102 and master device 104 each establish communication channels between each other when each client device 102 and master device 104 are going to perform the final transcript generation. In this case, each client device 102 and master device 104 needs to receive the recognition from every other client device 102 and master device 104. When performing the distributed solution, master device 104 may not be used as all client devices 102 are performing the final transcript generation.

At 308, any presentation materials are downloaded. For example, master device 104 may download a presentation that will be presented during the meeting. The presentation materials may be used to augment the final transcript, such as some recognized speech may be inserted into the presentation. Alternatively, the presentation material may be used to correct or augment the recognized speech. For example, some text in the presentation materials may be used to correct speech that is recognized.

At 310, client devices 102 and master device 104 start automatic speech recognition.

Automatic Speech Recognition

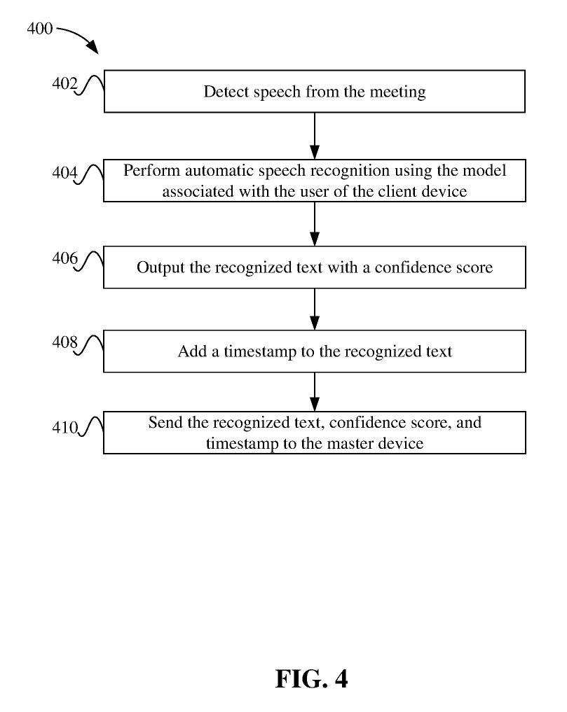

Each client device 102 and/or master device 104 may perform automatic speech recognition. FIG. 4 depicts a simplified flowchart 400 of a method for performing automatic speech recognition according to some embodiments. At 402, automatic speech recognition system 106 detects speech from the meeting. Then, at 404, automatic speech recognition system 106 performs automatic speech recognition using a model associated with the user of client device 102. For example, the model may have been trained by the user of client device 102 and is trained to recognize voice characteristics of that user.

At 406, automatic speech recognition system 106 outputs the recognized speech with a confidence score. The confidence score may indicate the confidence that automatic speech recognition system 106 has with respect to the recognition of the speech. For example, if automatic speech recognition system 106 is highly confident the recognized speech is accurate, then the confidence score is higher. Conversely, if automatic speech recognition system 106 is not confident the recognized speech is accurate, then the confidence score may be lower. Automatic speech recognition system 106 may generate the confidence score based on the recognition by a prediction network, which will be discussed in more detail below.

At 408, automatic speech recognition system 106 adds a time stamp to the recognized speech. For example, the time stamp may be a current time at which the recognized speech is generated, or may be an elapsed time from when the meeting started. The time stamp may be a single time or may be a time range, such as a time range from one minute to two minutes in the meeting or from 12:00 p.m. to 12:01 p.m. Also, every client 102 may add a time stamp at a fixed predefined interval, such as every second, 30 seconds, minute, etc.

At 410, automatic speech recognition system 106 sends the recognized speech, confidence score, and time stamp to master device 104. Master device 104 may be centrally performing the generation of the final transcript in this case. Alternatively, client device 102 may send the recognized speech, confidence score, and time stamp to other client devices 102 if the final transcript is being generated in a distributed fashion.

The above process continues as client device 102 continually recognizes text during the meeting. In real time, automatic speech recognition system 106 recognizes speech and performs speech recognition to generate recognized speech, which is sent to master device 104 and/or other client devices 102.

Final Transcript Generation

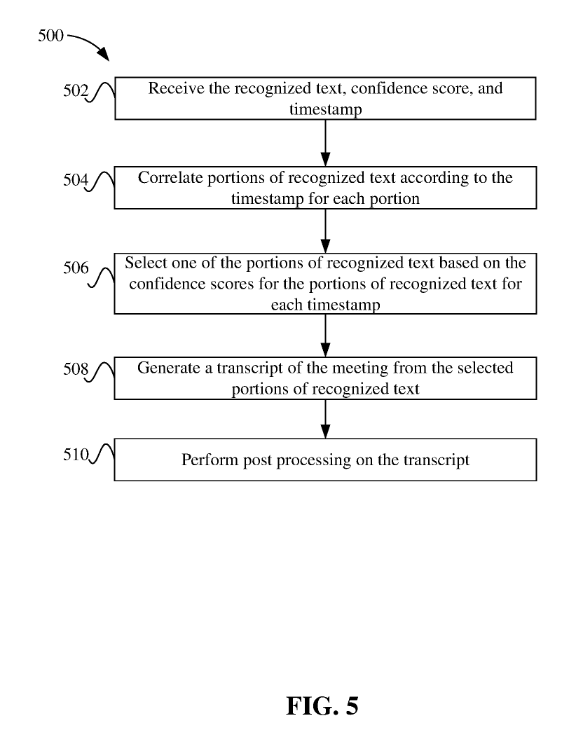

The following will describe automatic speech recognition manager 108 generating the final transcript according to some embodiments. Automatic speech recognition manager 108 may be included in master device 104 and/or one or more client devices 102. FIG. 5 depicts a simplified flowchart 500 of a method for generating a final transcript according to some embodiments. At 502, automatic speech recognition manager 108 receives the recognized speech, a confidence score, and a time stamp from client devices 102. The recognized speech may be received from client devices 102 at master device 104 or alternatively at client devices 102 from other client devices 102 and master device 104. The recognized speech may be portions of text that are received in real time as users speak during the meeting.

At 504, automatic speech recognition manager 108 correlates portions of text according to the time stamp for each portion. For example, each client device 102 and/or master device 104 may be performing automatic speech recognition when a user talks at a first time stamp. Each client device 102 and master device 104 generates a portion of text at that time stamp, which is received at automatic speech recognition manager 108. Automatic speech recognition manager 108 then correlates the portions of recognized speech together for the same time stamp.

At 506, automatic speech recognition manager 108 selects one of the portions of recognized speech based on the confidence scores for the portions of recognized speech for each time stamp. For example, for a first time stamp, there may be seven portions of recognized speech with seven confidence scores. Automatic speech recognition manager 108 selects the portion of recognized speech that has the highest confidence score for that first time stamp. Automatic speech recognition manager 108 selects the portions of text at each time stamp.

At 508, automatic speech recognition manager 108 generates a transcript of the meeting from the selected portions of recognized speech. Automatic speech recognition manager 108 generates the transcript from portions of text recognized by different client devices 102 and/or master device 104 such that the transcript is collaboratively generated by different devices. Some of the portions of text may have been recognized by client devices that may have performed a more accurate speech recognition. For example, because models in the different client devices 102 and master device 104 are trained for a specific user, when a specific user speaks, that automatic speech recognition system 106 may more accurately recognize the speech for that user than another automatic speech recognition system 106 that is not trained for that user's voice characteristics. The final transcript may then include the most accurate recognized speech. The transcript may be generated in real-time while the meeting is ongoing and communicated among the client devices 102.

At 510, automatic speech recognition manager 108 may perform post-processing on the transcript. For example, the post-processing may include highlighting important action items and actions required items, converting non-English text to English, tagging a line of the transcript with a user's name, writing follow-up questions, correcting spelling errors, correcting errors based on supplementary materials such as the presentation, and/or e-mailing the final transcript to all users that attended the meeting. Additionally, automatic speech recognition manager 108 may integrate the final transcript into presentation materials. For example, when a presentation slide is presented during the meeting, the recognized speech during the time that slide was displayed may be inserted into a note section of that slide. Also, it is noted the insertion of text from the recognized speech may be inserted in real-time while the slide is being presented.

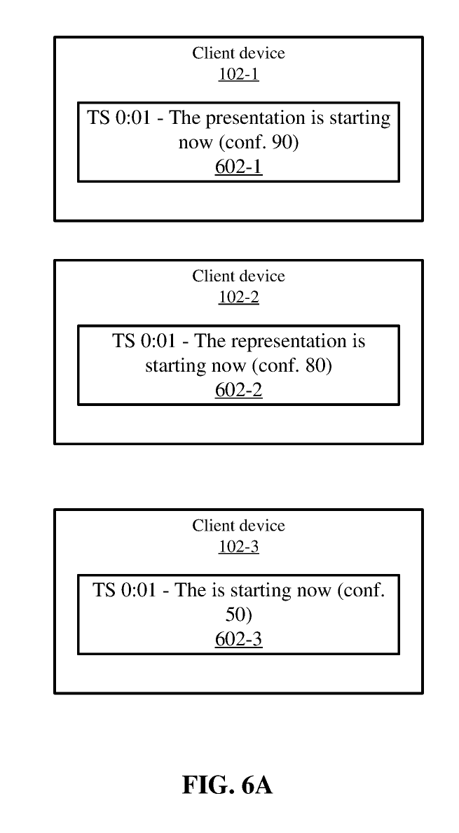

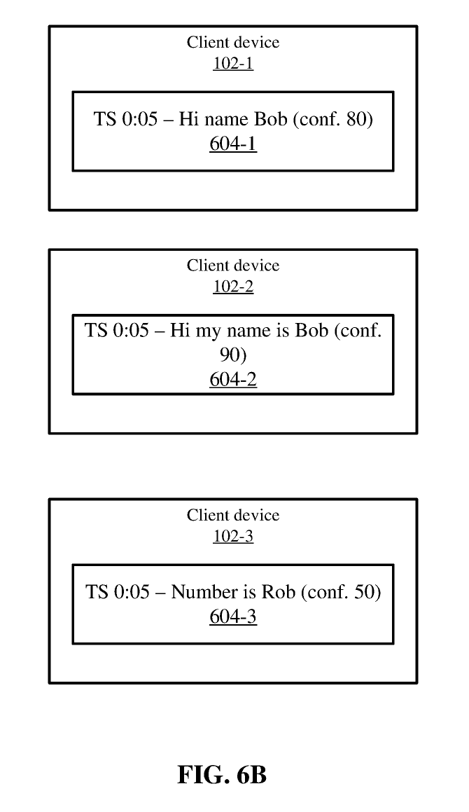

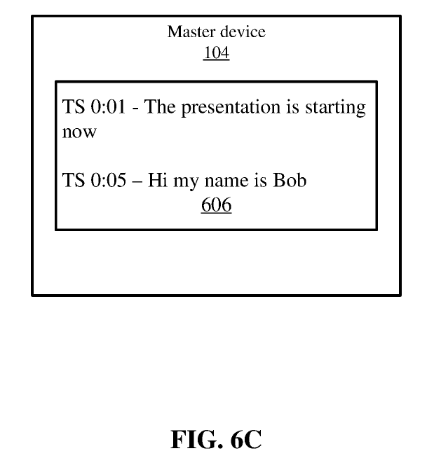

FIGS. 6A and 6B depict an example of selecting a portion of text according to some embodiments. FIG. 6A depicts portions of text at a first time stamp according to some embodiments. At 602-1, client device 102-1 recognized a portion of text at time stamp TS 0:01 of “The presentation is starting now”. The portion of text has a confidence score of “90”. Also, at 602-2, client device 102-2 recognized the portion of text at time stamp TS 0:01 as “The representation is starting now”, with a confidence score of “80”. At 602-3, client device 102-3 recognized the speech at time stamp TS 0:01 as “The is starting now”, with a confidence score of “50”. Other client devices 102 and master device 104 may also recognize portions of text for the speech, but are not described here.

Automatic speech recognition manager 108 may correlate these portions of text together based on the received time stamp being the same. Then, automatic speech recognition manager 108 selects one of the portions of text with the highest confidence score. In this case, automatic speech recognition manager 108 selects the portion of text at 602-1 of “The presentation is starting now” because this portion of text has the highest confidence score of 90.

FIG. 6B shows an example of portions of recognized speech at a second time stamp according to some embodiments. At 604-1, client device 102-1 recognizes a portion of text at a time stamp TS 0:05 as “Hi name Bob”, with a confidence score of “80”. At 604-2, client device 102-2 recognizes a portion of text at time stamp TS 0:05 as “Hi my name is Bob”, with a confidence score of “90”. Similarly, client device 102-3 recognizes the portion of text at time stamp TS 0:05 as “Number is Rob”, with a confidence score of “50”.

Automatic speech recognition manager 108 selects the portion of recognized speech at 604-2 of “Hi my name is Bob” because the confidence score of “90” is higher than the other confidence scores.

FIG. 6C shows an example of the final transcript according to some embodiments. For example, master device 104 may generate a final transcript that includes the text of “The presentation is starting” at time stamp 0:01 and the text of “Hi my name is Bob” at time stamp TS0:05. In some embodiments, a user who trained the model used by client device 102-1 recognized the text of “The presentation is starting now” and a second user trained the model used by client device 102-2 that recognized the text “Hi! My name is Bob”. This resulted in a more accurate recognition of the speech because the model was trained by the respective user that was speaking at that time.

Speech Recognition System

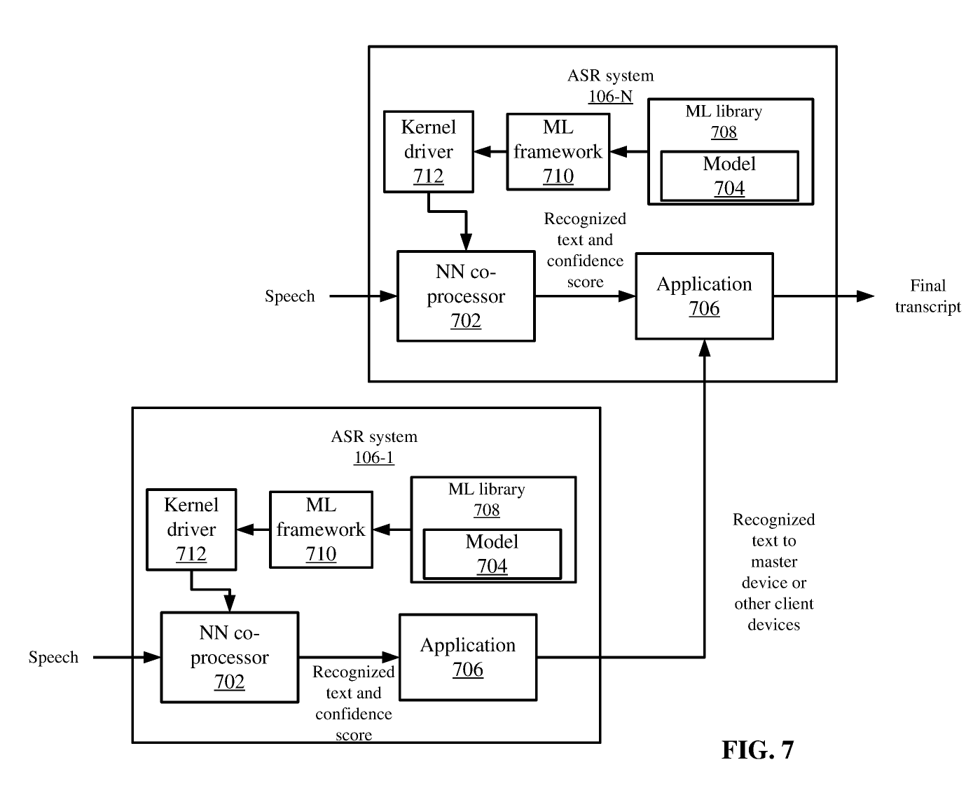

Different prediction networks may be used to perform the automatic speech recognition in automatic speech recognition system 106. FIG. 7 depicts an example of automatic speech recognition systems 106 according to some embodiments. Although this system is described, other systems may be used. Two automatic speech recognition systems 106-1 and 106-N are described. Automatic speech recognition system 106-1 is a client and automatic speech recognition system 106-N is the master. Both automatic speech recognition systems 106 include a neural network co-processor 702, a model 704, and an application 706. In some embodiments, neural network (NN) co-processor 702 is a Gaussian mixture model and neural networks accelerator co-processor that runs in parallel with a main computer processor of client device 102 or master device 104. Neural network co-processor 702 may perform automatic speech recognition (or tasks) using specialized logic in neural network co-processor 702.

A model 704 may be included in a machine learning library 708. Model 704 may be trained based on the process described above with respect to FIG. 2. A machine learning framework 710 is a structure of a program used to perform the machine learning for automatic speech recognition. Kernel driver 712 is software code that is running in a kernel to drive neural network co-processor 702. Neural network co-processor 702 receives a trained model 704 and speech, and then can output recognized speech. Neural network co-processor 702 recognizes speech based on an input of voice samples, which is processed using parameters of trained model 704. Different parameters may result in different recognition results, that is, the recognized speech may be slightly different based on the different parameters used in different trained models. In some embodiments, neural network co-processor 702 performs the automatic speech recognition using hardware instead of software, which allows the automatic speech recognition to be performed faster than the software implementation. In a real time environment, such as a meeting, the speed at which the speech recognition is performed may be important. An application 706 receives the recognized speech and can send the recognized speech to master device 104 and/or other client devices 102. Application 706 may also add a time stamp to the recognized speech. Neural network co-processor 702 also may output a confidence score with the recognized speech.

Automatic speech recognition system 106-1 sends the recognized text to automatic speech recognition system 106-N. Automatic speech recognition system 106-N then combines the analyzes its own recognized text and the recognized text from automatic speech recognition system 106-1 (and any other automatic speech recognition systems 106) to generate the final transcript, the process of which is described herein.

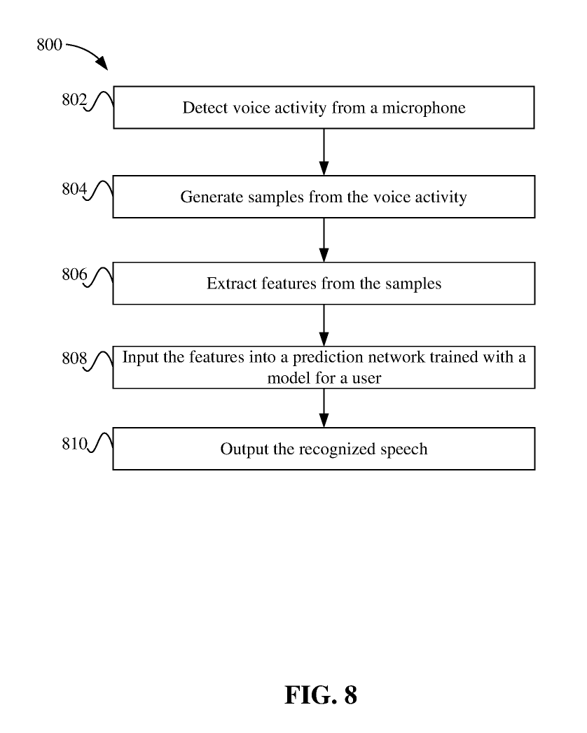

FIG. 8 depicts a simplified flowchart 800 of a method for performing automatic speech recognition according to some embodiments. At 802, client device 102 detects voice activity from a microphone. Then, at 804, client device 102 generates samples from the voice activity. For example, audio received may be broken into samples for set time units.

At 806, automatic speech recognition system 106 extracts features from the samples. The features may be characteristics that are extracted from the audio.

At 808, automatic speech recognition system 106 inputs the features into a prediction network trained with the model for the user of client device 102. This model may have been trained based on recognizing voice with certain voice characteristics of the user.

At 810, the prediction network outputs the recognized speech. Also, the recognized speech may be associated with a confidence score. The confidence score may be higher when a user that trained the model speaks at the meeting and lower when a user other than the user that trained the model speaks in the meeting. Different automatic speech recognition system 106 output different recognized speech and also confidence scores depending on the model used.

### CONCLUSION

Accordingly, some embodiments generate a transcript of a meeting in which multiple users are speaking using a collaborative automatic speech recognition system. Specific client devices 102 and master device 104 may be trained to recognize the speech of specific users. Then, the final transcript is generated based on the recognized speech from multiple client devices 102. In most cases, the portions of recognized speech are selected based on the client device 102 that recognized the speech using a model from the user that was speaking. There may be certain portions that may not be recognized with the model of a specific user that is speaking, such as when the user is far away from the user's associated client device. However, in most cases, especially if the user is sifting in front of an associated client device 102, that client device 102 may perform the most accurate transcription of the user's speech.

In some embodiments, a method for performing collaborative automatic speech recognition is provided. The method includes: receiving, by a computing device, a plurality of portions of recognized speech from a plurality of devices, each portion including an associated confidence score and time stamp; for one or more time stamps associated with the plurality of portions, identifying, by the computing device, two or more confidence scores for two or more of the plurality of portions of recognized speech; selecting, by the computing device, for the one or more time stamps, one of the two or more of the plurality of portions of recognized speech based on the two or more confidence scores for the two or more of the plurality of portions; and generating, by the computing device, a transcript using the one of the two or more of the plurality of portions of recognized speech selected for the respective one or more time stamps.

In some embodiments, the plurality of portions of recognized speech are recognized using a plurality of automatic speech recognition systems that are using differently trained models.

In some embodiments, the differently trained models include different parameters that are used by respective automatic speech recognition systems to recognize speech.

In some embodiments, a model for an automatic speech recognition system in one of the plurality of devices is trained using speech samples from a user.

In some embodiments, the model of the automatic speech recognition system is also trained using standardized speech samples from other users.

In some embodiments, a model for an automatic speech recognition system in a device in the plurality of devices is trained using standardized speech samples that are altered based on characteristics of speech samples from a user.

In some embodiments, each of the plurality of devices include an automatic speech recognition system that includes a model trained based on speech characteristics of an associated user of the device.

In some embodiments, the method includes initializing a meeting for the plurality of devices, wherein the computing device establishes a communication channel with each of the plurality of devices to receive the plurality of portions of recognized speech.

In some embodiments, each of the plurality of devices communicates the plurality of portions of recognized speech to each other.

In some embodiments, each of the plurality of devices generates the transcript.

In some embodiments, the method includes post-processing the transcript to alter the transcript.

In some embodiments, the method includes adding an item to the transcript to alter the transcript.

In some embodiments, the method includes: downloading presentation materials; and adding at least a portion of the transcript to the presentation materials.

In some embodiments, one of the plurality of portions of recognized speech is from speech samples from a user, each of the plurality of devices recognizes the one of the plurality of portions of recognized speech from the speech samples from the user, and the one of the plurality of portions of recognized speech from each of the plurality of devices each includes a different confidence score.

In some embodiments, a non-transitory computer-readable storage medium having stored thereon computer executable instructions for performing collaborative automatic speech recognition is provided. The instructions, when executed by a computer device, cause the computer device to be operable for: receiving a plurality of portions of recognized speech from a plurality of devices, each portion including an associated confidence score and time stamp; for one or more time stamps associated with the plurality of portions, identifying two or more confidence scores for two or more of the plurality of portions of recognized speech; selecting for the one or more time stamps, one of the two or more of the plurality of portions of recognized speech based on the two or more confidence scores for the two or more of the plurality of portions; and generating a transcript using the one of the two or more of the plurality of portions of recognized speech selected for the respective one or more time stamps.

In some embodiments, the plurality of portions of recognized speech are recognized using a plurality of automatic speech recognition systems that are using differently trained models.

In some embodiments, a model for an automatic speech recognition system in one of the plurality of devices is trained using speech samples from a user.

In some embodiments, a model for an automatic speech recognition system in a device in the plurality of devices is trained using standardized speech samples that are altered based on characteristics of speech samples from a user.

In some embodiments, each of the plurality of devices include an automatic speech recognition system that includes a model trained based on speech characteristics of an associated user of the device.

In some embodiments, an apparatus for performing collaborative automatic speech recognition is provided. The apparatus includes: one or more computer processors; and a computer-readable storage medium comprising instructions for controlling the one or more computer processors to be operable for: receiving a plurality of portions of recognized speech from a plurality of devices, each portion including an associated confidence score and time stamp; for one or more time stamps associated with the plurality of portions, identifying two or more confidence scores for two or more of the plurality of portions of recognized speech; selecting for the one or more time stamps, one of the two or more of the plurality of portions of recognized speech based on the two or more confidence scores for the two or more of the plurality of portions; and generating a transcript using the one of the two or more of the plurality of portions of recognized speech selected for the respective one or more time stamps.

In some embodiments, the plurality of portions of recognized speech are recognized using a plurality of automatic speech recognition systems that are using differently trained models.

In some embodiments, a model for an automatic speech recognition system in one of the plurality of devices is trained using speech samples from a user.

In some embodiments, a model for an automatic speech recognition system in a device in the plurality of devices is trained using standardized speech samples that are altered based on characteristics of speech samples from a user.

In some embodiments, an apparatus for performing collaborative automatic speech recognition is provided. The apparatus includes: means for receiving a plurality of portions of recognized speech from a plurality of devices, each portion including an associated confidence score and time stamp; means for identifying two or more confidence scores for two or more of the plurality of portions of recognized speech for one or more time stamps associated with the plurality of portions; means for selecting for the one or more time stamps, one of the two or more of the plurality of portions of recognized speech based on the two or more confidence scores for the two or more of the plurality of portions; and means for generating a transcript using the one of the two or more of the plurality of portions of recognized speech selected for the respective one or more time stamps.

In some embodiments, the plurality of portions of recognized speech are recognized using a plurality of automatic speech recognition systems that are using differently trained models.

System

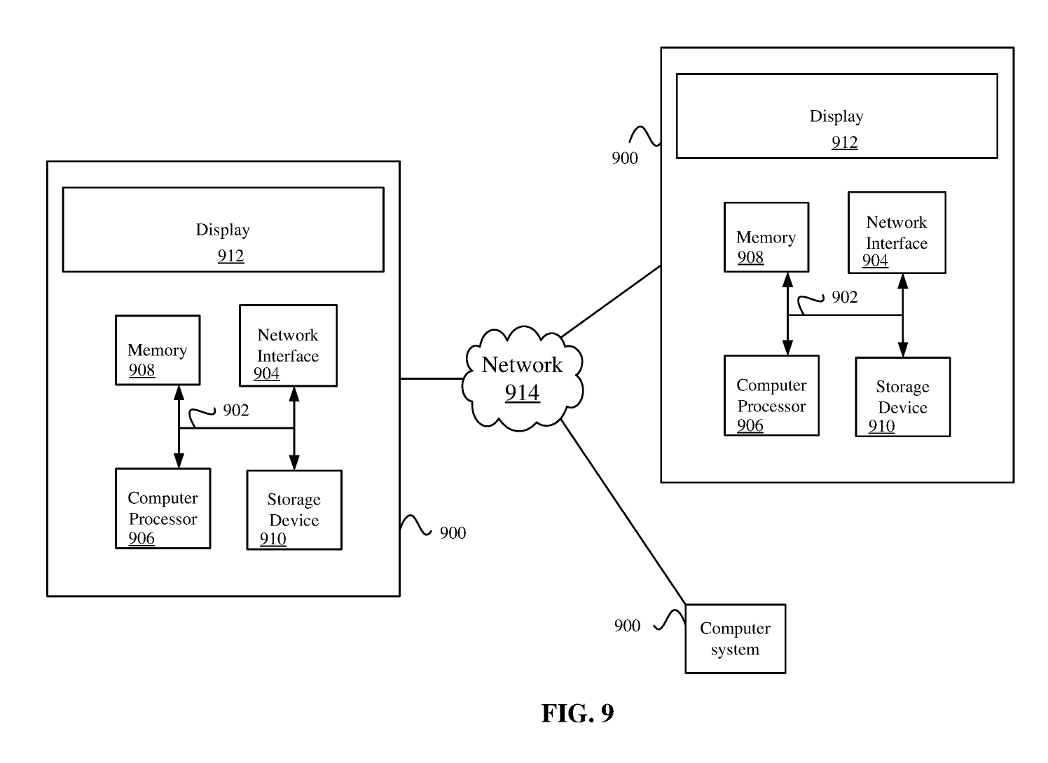

FIG. 9 illustrates an example of special purpose computer systems 900 according to one embodiment. Computer system 900 includes a bus 902, network interface 904, a computer processor 906, a memory 908, a storage device 910, and a display 912.

Bus 902 may be a communication mechanism for communicating information. Computer processor 906 may execute computer programs stored in memory 908 or storage device 908. Any suitable programming language can be used to implement the routines of some embodiments including C, C++, Java, assembly language, etc. Different programming techniques can be employed such as procedural or object oriented. The routines can execute on a single computer system 900 or multiple computer systems 900. Further, multiple computer processors 906 may be used.

Memory 908 may store instructions, such as source code or binary code, for performing the techniques described above. Memory 908 may also be used for storing variables or other intermediate information during execution of instructions to be executed by processor 906. Examples of memory 908 include random access memory (RAM), read only memory (ROM), or both.

Storage device 910 may also store instructions, such as source code or binary code, for performing the techniques described above. Storage device 910 may additionally store data used and manipulated by computer processor 906. For example, storage device 910 may be a database that is accessed by computer system 900. Other examples of storage device 910 include random access memory (RAM), read only memory (ROM), a hard drive, a magnetic disk, an optical disk, a CD-ROM, a DVD, a flash memory, a USB memory card, or any other medium from which a computer can read.

Memory 908 or storage device 910 may be an example of a non-transitory computer-readable storage medium for use by or in connection with computer system 900. The non-transitory computer-readable storage medium contains instructions for controlling a computer system 900 to be configured to perform functions described by some embodiments. The instructions, when executed by one or more computer processors 906, may be configured to perform that which is described in some embodiments.

Computer system 900 includes a display 912 for displaying information to a computer user. Display 912 may display a user interface used by a user to interact with computer system 900.

Computer system 900 also includes a network interface 904 to provide data communication connection over a network, such as a local area network (LAN) or wide area network (WAN). Wireless networks may also be used. In any such implementation, network interface 904 sends and receives electrical, electromagnetic, or optical signals that carry digital data streams representing various types of information.

Computer system 900 can send and receive information through network interface 904 across a network 914, which may be an Intranet or the Internet. Computer system 900 may interact with other computer systems 900 through network 914. In some examples, client-server communications occur through network 914. Also, implementations of some embodiments may be distributed across computer systems 900 through network 914.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method for performing collaborative automatic speech recognition, the method comprising:
receiving, by a computing device, a plurality of portions of recognized speech from a plurality of devices, each portion including an associated confidence score and time stamp;
for one or more time stamps associated with the plurality of portions, identifying, by the computing device, two or more confidence scores for two or more of the plurality of portions of recognized speech;
selecting, by the computing device, for the one or more time stamps, one of the two or more of the plurality of portions of recognized speech based on the two or more confidence scores for the two or more of the plurality of portions; and
generating, by the computing device, a transcript using the one of the two or more of the plurality of portions of recognized speech selected for the respective one or more time stamps.

2. The method of claim 1, wherein the plurality of portions of recognized speech are recognized using a plurality of automatic speech recognition systems that are using differently trained models.

3. The method of claim 2, wherein the differently trained models include different parameters that are used by respective automatic speech recognition systems to recognize speech.

4. The method of claim 1, wherein a model for an automatic speech recognition system in one of the plurality of devices is trained using speech samples from a user.

5. The method of claim 4, wherein the model of the automatic speech recognition system is also trained using standardized speech samples from other users.

6. The method of claim 1, wherein a model for an automatic speech recognition system in a device in the plurality of devices is trained using standardized speech samples that are altered based on characteristics of speech samples from a user.

7. The method of claim 1, wherein each of the plurality of devices include an automatic speech recognition system that includes a model trained based on speech characteristics of an associated user of the device.

8. The method of claim 1, further comprising:
initializing a meeting for the plurality of devices, wherein the computing device establishes a communication channel with each of the plurality of devices to receive the plurality of portions of recognized speech.

9. The method of claim 1, wherein each of the plurality of devices communicates the plurality of portions of recognized speech to each other.

10. The method of claim 7, wherein each of the plurality of devices generates the transcript.

11. The method of claim 1, further comprising:
post-processing the transcript to alter the transcript.

12. The method of claim 1, further comprising:
adding an item to the transcript to alter the transcript.

13. The method of claim 1, further comprising:
downloading presentation materials; and
adding at least a portion of the transcript to the presentation materials.

14. The method of claim 1, wherein:
one of the plurality of portions of recognized speech is from speech samples from a user,
each of the plurality of devices recognizes the one of the plurality of portions of recognized speech from the speech samples from the user, and
the one of the plurality of portions of recognized speech from each of the plurality of devices each includes a different confidence score.

15. A non-transitory computer-readable storage medium having stored thereon computer executable instructions for performing collaborative automatic speech recognition, wherein the instructions, when executed by a computer device, cause the computer device to be operable for:
receiving a plurality of portions of recognized speech from a plurality of devices, each portion including an associated confidence score and time stamp;
for one or more time stamps associated with the plurality of portions, identifying two or more confidence scores for two or more of the plurality of portions of recognized speech;
selecting for the one or more time stamps, one of the two or more of the plurality of portions of recognized speech based on the two or more confidence scores for the two or more of the plurality of portions; and
generating a transcript using the one of the two or more of the plurality of portions of recognized speech selected for the respective one or more time stamps.

16. The non-transitory computer-readable storage medium of claim 15, wherein the plurality of portions of recognized speech are recognized using a plurality of automatic speech recognition systems that are using differently trained models.

17. The non-transitory computer-readable storage medium of claim 15, wherein a model for an automatic speech recognition system in one of the plurality of devices is trained using speech samples from a user.

18. The non-transitory computer-readable storage medium of claim 15, wherein a model for an automatic speech recognition system in a device in the plurality of devices is trained using standardized speech samples that are altered based on characteristics of speech samples from a user.

19. The non-transitory computer-readable storage medium of claim 15, wherein each of the plurality of devices include an automatic speech recognition system that includes a model trained based on speech characteristics of an associated user of the device.

20. An apparatus for performing collaborative automatic speech recognition, the apparatus comprising:
one or more computer processors; and
a computer-readable storage medium comprising instructions for controlling the one or more computer processors to be operable for:
receiving a plurality of portions of recognized speech from a plurality of devices, each portion including an associated confidence score and time stamp;
for one or more time stamps associated with the plurality of portions, identifying two or more confidence scores for two or more of the plurality of portions of recognized speech;
selecting for the one or more time stamps, one of the two or more of the plurality of portions of recognized speech based on the two or more confidence scores for the two or more of the plurality of portions; and
generating a transcript using the one of the two or more of the plurality of portions of recognized speech selected for the respective one or more time stamps.

21. The apparatus of claim 20, wherein the plurality of portions of recognized speech are recognized using a plurality of automatic speech recognition systems that are using differently trained models.

22. The apparatus of claim 20, wherein a model for an automatic speech recognition system in one of the plurality of devices is trained using speech samples from a user.

23. The apparatus of claim 20, wherein a model for an automatic speech recognition system in a device in the plurality of devices is trained using standardized speech samples that are altered based on characteristics of speech samples from a user.

24. An apparatus for performing collaborative automatic speech recognition, the apparatus comprising:
means for receiving a plurality of portions of recognized speech from a plurality of devices, each portion including an associated confidence score and time stamp;
means for identifying two or more confidence scores for two or more of the plurality of portions of recognized speech for one or more time stamps associated with the plurality of portions;
means for selecting for the one or more time stamps, one of the two or more of the plurality of portions of recognized speech based on the two or more confidence scores for the two or more of the plurality of portions; and
means for generating a transcript using the one of the two or more of the plurality of portions of recognized speech selected for the respective one or more time stamps.

25. The apparatus of claim 24, wherein the plurality of portions of recognized speech are recognized using a plurality of automatic speech recognition systems that are using differently trained models.
